(19) United States
(12) Patent Application Publication
(10) Pub. No.: US 2026/0116225 A1
(43) Pub. Date: Apr. 30, 2026

(54) CHARGING CONNECTION DEVICE FOR ELECTRIC VEHICLES

(71) Applicants: HYUNDAI MOTOR COMPANY, Seoul (KR); KIA CORPORATION, Seoul (KR)

(72) Inventors: Dae Hyun KIM, Hwaseong-si (KR); Sangjin LEE, Hwaseong-si (KR)

(73) Assignees: HYUNDAI MOTOR COMPANY, Seoul (KR); KIA CORPORATION, Seoul (KR)

(21) Appl. No.: 19/222,383

(22) Filed: May 29, 2025

(30) Foreign Application Priority Data
Oct. 28, 2024 (KR) 10-2024-0148565

(51) Int. Cl. B60L 53/16; B60L 53/31

(52) U.S. Cl. CPC B60L 53/16; B60L 53/31

(57) ABSTRACT

A charging connection device for electric vehicles is provided. The charging connection device includes a charging connector, inlet plug, fastening socket, and shock-absorbing unit. The charging connector receives power from a charger and connects to the vehicle's charging port. The fastening socket, located on the connector, holds a conductive conductor that interfaces with the conductive terminal of the inlet plug mounted on the charging port. When the inlet plug is inserted, the shock-absorbing unit deforms elastically, providing a secure electrical connection. Upon removal, the unit returns to its standby state, providing reliable and stress-free coupling.

### CROSS-REFERENCE TO RELATED APPLICATION(S)

This application is based on and claims the benefit of 35 U.S.C. 119 to Korean Patent Application No. 10-2024-0148565, filed on Oct. 18, 2024, in the Korean Intellectual Property Office, the disclosure of which is herein incorporated by reference in its entirety.

### TECHNICAL FIELD

The present disclosure relates to a charging connection device for electric vehicles, and more specifically to a charging connection device capable of reducing physical impact between a charging terminal of an electric vehicle and an external charging connector and securing a (e.g., sufficient) contact area between terminals.

### BACKGROUND

As electric vehicles become widespread, there is increasing demand for infrastructure for charging of a battery. An electric vehicle stores electric energy supplied from an external charger in a battery mounted therein, and is driven using the stored electric energy. Therefore, during the battery charging process, stability, and efficiency should be considered and provided.

A general charging system is configured to connect an external charging connector to a charging terminal to supply power.

A charger may be physically coupled and electrically connected to a battery to transmit power to the battery. However, in such a general charging system, if coupling between the charging terminal and the charging connector is not stable, power loss may occur, and there is even a risk of personal injury.

Further, physical coupling between the charging terminal and the charging connector causes great variation in charging efficiency depending on the surrounding environment. The charging terminal and the charging connector physically coupled (e.g., to each other) are vulnerable to external force applied thereto.

Furthermore, if a (e.g., sufficient) electrical contact area is not secured, parts in electrical contact (e.g., with each other) may overheat, or power loss may occur during fast charging or supply of high power.

Thus, if the contact area is not secure, the durability of the battery charging system may be adversely impacted, as well as the charging efficiency may be adversely affected.

Therefore, it would be useful to provide at least a secure contact area.

### SUMMARY

In an example embodiment, when a charging terminal of an electric vehicle and an external charging connector are electrically connected (e.g., to each other), the present disclosure secures a suitable (e.g., sufficient) contact area between conductors.

In an example embodiment, a conductive conductor of an electric vehicle charging system and a terminal are directed to minimizing worn, deformed, or damaged connections for charging of a battery.

In an example embodiment, another aspect of the present disclosure is directed to addressing charging efficiency that is deteriorated or charging that is interrupted due to vibration or impact occurring at the time of connection and disconnection between a charging port and a charging connector or due to external force applied to the charging port and the charging connector during charging.

The present disclosure is not limited to those mentioned herein, and other aspects or objects not mentioned herein may be understood from the following description.

A charging connection device for electric vehicles according to an example embodiment of the present disclosure includes a charging connector, an inlet plug, a fastening socket, and a shock-absorbing unit. The charging connector is connected to a charger (e.g., power source) to receive electrical energy, and is coupled to a charging port provided at an electric vehicle. The fastening socket is provided at the charging connector, and the inlet plug mounted to the charging port is fitted into a conductive conductor mounted in the fastening socket, so a conductive terminal mounted to the inlet plug comes into direct contact with the fastening socket. When the inlet plug is fit into the fastening socket, the shock-absorbing unit is (e.g., elastically) deformed to provide for (e.g., allow) the conductor to enter an electrical connection state. When the inlet plug is separated from the fastening socket, the shock-absorbing unit provides for (e.g., allows) the conductor to return to a standby state.

In the charging connection device for electric vehicles according to the example embodiment of the present disclosure, the fastening socket may include a base forming a portion of an outer side surface of the charging connector coupled to the charging port while facing the charging port, a fixed plate configured to position (e.g., fix) the conductor at a position in front of the base, and a hollow cylindrical socket body including an open surface facing the base and a surface formed opposite the base and provided with a socket head. The shock-absorbing unit may be a compression spring disposed between the base and the socket body. When external force is applied to the socket body, the shock-absorbing unit may be (e.g., elastically) compressed to reduce an interval between the base and the socket body, and when the external force applied to the socket body is removed, the shock-absorbing unit may provide for (e.g., allow) the socket body to return to the original position thereof.

In the charging connection device for electric vehicles according to the example embodiment of the present disclosure, the socket body may include a moving plate formed as an annular rim along the outer periphery of the open surface thereof facing the base and a spacer extending from the moving plate toward the base to limit a moving distance of the socket body approaching the base.

In the charging connection device for electric vehicles according to the example embodiment of the present disclosure, the socket body, the socket head, the moving plate, the spacer, and the fixed plate may be provided in (e.g., made of) an insulative material.

In the charging connection device for electric vehicles according to the example embodiment of the present disclosure, the electrical connection state may be a state in which, as the socket body slides toward the base, the socket head approaches the conductor accommodated in the socket body, thereby increasing the (e.g., direct) contact area between the conductor and the terminal entering the socket body through the socket head.

In the charging connection device for electric vehicles according to the example embodiment of the present disclosure, the fastening socket may include a base forming a portion of an outer side surface of the charging connector coupled to the charging port while facing the charging port, a fixed plate configured to fix the conductor at a position in front of the base, and a hollow cylindrical socket body including an open surface facing the base and a surface formed opposite the base and provided with a socket head. The shock-absorbing unit may include a first damping unit provided between the base and the socket body, and the first damping unit may alleviate vibration and shock applied to the socket body against the base.

In the charging connection device for electric vehicles according to the example embodiment of the present disclosure, the fastening socket may include a base forming a portion of an outer side surface of the charging connector coupled to the charging port while facing the charging port, a hollow cylindrical socket body fixed in front of the base, the socket body including an open surface facing the base and a surface formed opposite the base and provided with a socket head, and a shock-absorbing end configured to provide (e.g., allow) one end of the conductor to be coupled thereto and to provide for (e.g., allow) the conductor to enter the socket body through the open surface of the socket body and (e.g., linearly) reciprocate. The shock-absorbing unit may include a second damping unit provided between the base and the shock-absorbing end. When external force is applied to the conductor, the second damping unit may provide for (e.g., allow) the shock-absorbing end to move toward the base, and when the external force applied to the conductor is removed, the second damping unit may provide for (e.g., allow) the shock-absorbing end to return to the original position thereof.

A charging connection device according to at least one example embodiment of the present disclosure is implemented as a charging connection device provided at an electric vehicle to provide for (e.g., allow) a charging connector of a charger to be fastened thereto to charge a battery, and includes a charging port, a terminal, a pressing end, and a plug tip. The charging port is provided at the electric vehicle for (e.g. to allow) the charging connector to be fastened thereto. The terminal is a conductive terminal protruding (e.g., linearly) forward from the charging port. The pressing end protrudes outward along the outer periphery of the lower end portion of the terminal to have a stepped shape. The plug tip is provided at the front end of the terminal.

In the charging connection device according to at least one example embodiment of the present disclosure, the plug tip may be provided in (e.g., made of) an elastically deformable insulative material.

### BRIEF DESCRIPTION OF THE DRAWINGS

The above and other objects and features of the present disclosure may be understood from the following description and the accompanying drawings, in which:

FIG. 1 is a schematic view of a charging system providing a charging connection device for electric vehicles according to an embodiment of the present disclosure;

FIG. 2 is a cross-sectional view of the charging connection device for electric vehicles according to an embodiment of the present disclosure to provide a “standby state” in which a fastening socket and an inlet plug are separated from each other;

FIG. 3 is a cross-sectional view of the charging connection device for electric vehicles according to an embodiment of the present disclosure to provide an “electrical connection state” in which the inlet plug is coupled to the fastening socket;

FIGS. 4 and 5 are cross-sectional views of a charging connection device for electric vehicles according to another embodiment of the present disclosure; and

FIGS. 6 and 7 are cross-sectional views of a charging connection device for electric vehicles according to still another embodiment of the present disclosure.

### DETAILED DESCRIPTION

Hereinafter, embodiments of the present disclosure will be provided with reference to the accompanying drawings.

In the drawings, the same or similar components are denoted by the same or similar reference numerals, and a redundant description thereof may be omitted.

When a component is referred to as being “connected to” or “coupled to” another component, it may be (e.g., directly) connected to or coupled to the other component, or intervening components may be present. In contrast, when a component is referred to as being “directly connected,” or “directly coupled,” to another component, there are no intervening components present.

The terms “comprise”, “include”, and “have”, when used herein, may specify the presence of stated features, integers, steps, operations, elements, components, or combinations thereof, but may not preclude the presence or addition of one or more other features, integers, steps, operations, elements, components, or combinations thereof.

The first direction X, the second direction Y, and the third direction Z described herein refer to respective dimensions and directions thereof in a three-dimensional coordinate system used to describe a three-dimensional shape. Thus, the first direction X, the second direction Y, and the third direction Z are directions provided (e.g., defined) in dimensions orthogonal (e.g., to each other).

The present disclosure discloses a charging connection device for an electric vehicle 1.

The charging connection device for the electric vehicle 1 according to an example embodiment of the present disclosure is a device for supplying power to a battery from a power source.

The present disclosure relates to a connection device for electrically connecting a charger 2 (or charging station), which is a power source, to a battery mounted in the electric vehicle 1.

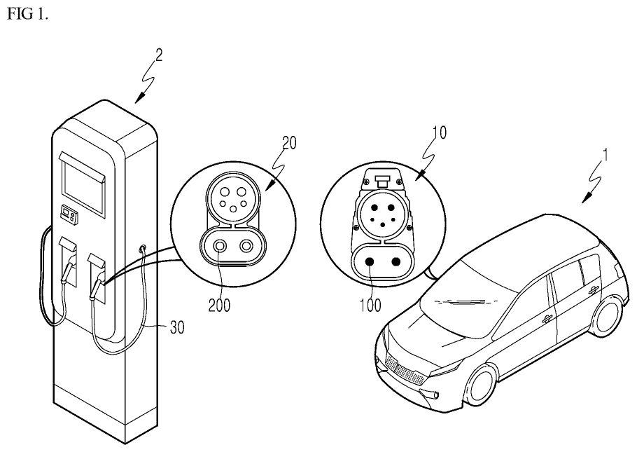

FIG. 1 is a schematic view of a charging system providing the charging connection device for the electric vehicle 1 according to an example embodiment of the present disclosure.

As shown in FIG. 1, the charging connection device according to an example embodiment of the present disclosure may be mounted to one of a charging port 10 provided at the electric vehicle 1 and a charger 2 mounted at a (e.g., certain) place as a power source to charge a battery.

The electric vehicle 1 is provided with a charging port 10 through which power is supplied to the battery.

In addition, the charger 2 as a power source is provided with a charging connector 20, which is connected to a supply cable 30.

The charging connector 20 may be separated from the charger 2 and may move by the length of the supply cable 30.

The charging connector 20 is connected to the charging port 10 of the electric vehicle 1 parked near the charger 2.

The charging connection device according to the example embodiment of the present disclosure may include a fastening socket 200 provided at the charging connector 20 and an inlet plug 100 provided at the charging port 10. Alternatively, the charging connection device according to the example embodiment of the present disclosure may be implemented as a device that also includes both the charging connector 20 and the charging port 10 at which the fastening socket 200 and the inlet plug 100 are provided, respectively.

That is, the charging connection device according to the example embodiment of the present disclosure may be implemented and embodied as the charging connector 20 at which the fastening socket 200 is provided or as the charger 2.

Alternatively, the charging connection device according to the example embodiment of the present disclosure may be implemented and embodied as the charger of the electric vehicle 1 at which the inlet plug 100 is provided.

Alternatively, the charging connection device according to the example embodiment of the present disclosure may be provided in the form of, for example, an electric vehicle charging device including the above components, a connection device, or an electric vehicle charging system.

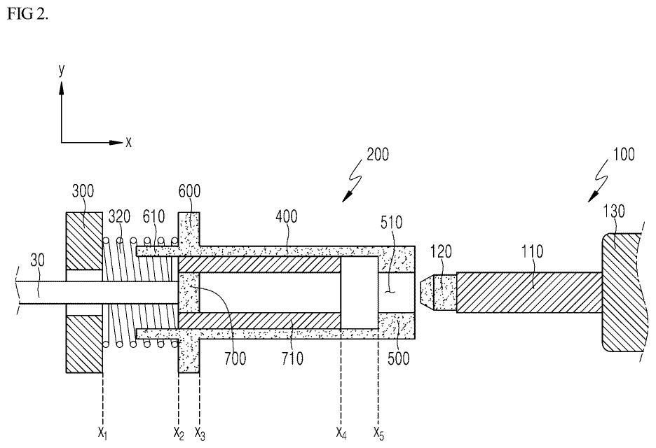

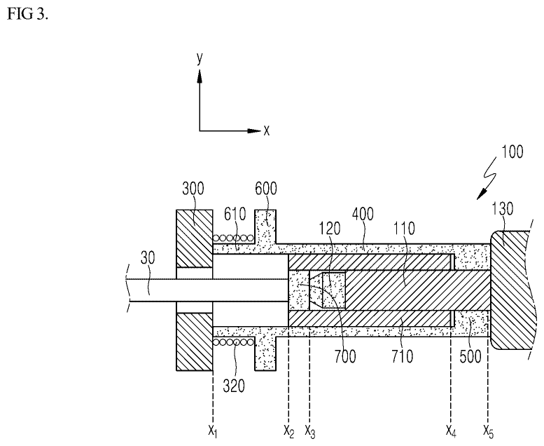

FIG. 2 is a cross-sectional view of the charging connection device for the electric vehicle 1 according to an example embodiment of the present disclosure to provide a “standby state” in which the fastening socket 200 and the inlet plug 100 are separated (e.g., from each other). FIG. 3 is a cross-sectional view of the charging connection device for the electric vehicle 1 according to an embodiment of the present disclosure to provide an “electrical connection state” in which the inlet plug 100 is coupled to the fastening socket 200.

As shown in FIGS. 2 and 3, the charging connection device according to the example embodiment of the present disclosure includes a charging port 10, a charging connector 20, an inlet plug 100, a fastening socket 200, and a shock-absorbing unit 320.

The charging port 10 is a terminal for charging a battery mounted in the electric vehicle 1. The charging port 10 may be mounted to the outer side of the electric vehicle 1. The charging port 10 is (e.g., physically) coupled to the charger 2, which is a separate power source, to receive electric energy.

The inlet plug 100 is provided on the front surface of the charging port 10. The inlet plug 100 may be formed to protrude straight forward from the charging port 10. In some example embodiments of the present disclosure, the inlet plug 100 may be provided in plural. Each inlet plug 100 is coupled and electrically connected to the fastening socket 200 provided at the charging connector 20.

The charging connector 20 is connected to the charger 2, which is a power source, through a supply cable 30. The charging connector 20 is coupled to the charging port 10 to transmit power to the battery of the electric vehicle 1 through the inlet plug 100 of the charging port 10.

A portion of the outer surface of the charging connector 20, which faces the charging port 10 when the charging connector 20 is coupled to the charging port 10, is formed as a base 300. The front surface of the base 300 that faces the charging port 10 is provided (e.g., defined) as an operation surface 310.

The inlet plug 100 protrudes straight forward from the charging port 10. A pressing end 130 may be provided at a base portion of the inlet plug 100. The pressing end 130 may have a stepped shape that has a larger cross-sectional area than a conductive terminal 110 and has an external appearance protruding in an outward direction from a base portion of the terminal 110.

That is, the terminal 110 is formed as a linear conductor and extends (e.g., linearly) forward from the pressing end 130, and an insulative plug tip 120 is coupled to the distal end of the terminal 110. The plug tip 120 is made of a (e.g., highly) elastic material in order to protect the terminal 110, which may have (e.g., relatively) (e.g., high) hardness, and may mitigate an impact when the inlet plug 100 is coupled to the fastening socket 200.

A conductor 710, which is conductive, may be provided to be coupled (e.g., fixed) relative to the base 300.

The conductor 710 may be coupled to a fixed plate 700, which is mounted so as to be spaced a predetermined interval from the operation surface 310 of the base 300 and maintained in a fixed state. One end of the conductor 710 may be coupled and fixed to the fixed plate 700.

The conductor 710 may have a coupling recess formed therein in the longitudinal direction thereof. The plug tip 120 and the terminal 110 of the inlet plug 100 may be received in the coupling recess in the conductor 710.

The fastening socket 200 comprises a socket body 400, a socket head 500, the base 300, and the conductor 710.

The socket body 400 may be a hollow cylindrical case. The conductor 710 may be accommodated in the (e.g., empty) interior of the socket body 400. The surface of the socket body 400 that faces the base 300 is open, and the opposite surface of the socket body 400 is provided with a socket head 500.

The socket head 500 includes (e.g., comprises) a fastening hole 510 formed in the central portion thereof. The fastening hole 510 is an entrance into which the inlet plug 100 provided at the charging port 10 is inserted in an order in which the distal end of the inlet plug 100 first enters the fastening hole 510.

In an example embodiment, the plug tip 120 located at the leading end of the inlet plug 100 first passes through the fastening hole 510 in the fastening socket 200 corresponding thereto and enters the socket body 400.

The plug tip 120 and the terminal 110 having entered the socket body 400 through the fastening hole 510 are fitted into the coupling recess in the aforementioned conductor 710.

A moving plate 600, which extends outward, may be provided along the outer periphery of the open surface of the socket body 400. The moving plate 600 may have an annular ring shape formed along the outer periphery of the socket body 400.

There also may be provided a spacer 610 that extends a predetermined length from the moving plate 600 toward the base 300.

The spacer 610 may be provided in plural. When the socket body 400 slides toward the base 300, the spacers 610 may restrict the interval between the operation surface 310 of the base 300 and the moving plate 600 from decreasing to a predetermined interval or less.

The shock-absorbing unit 320 is provided between the socket body 400 and the operation surface 310 of the base 300. In an example embodiment, the shock-absorbing unit 320 may be mounted between the moving plate 600 formed at the socket body 400 and the operation surface 310 of the base 300.

When the charging connector 20 and the charging port 10 are coupled (e.g., to each other), and the inlet plug 100 formed at the charging port 10 enters the fastening socket 200, the shock-absorbing unit 320 absorbs external force applied to the fastening socket 200.

In an example embodiment, when the socket body 400, which surrounds the outer peripheries of the fixed plate 700 and the conductor 710 fixed relative to the base 300, slides toward the operation surface 310 of the base 300, the shock-absorbing unit 320 absorbs energy through elastic deformation thereof. When the external force applied to the socket body 400 is removed, the shock-absorbing unit 320 provides for (e.g., allows) the socket body 400 to return to the original position thereof.

In an example embodiment, the shock-absorbing unit 320 may be implemented as a compression spring.

As described herein, when the socket body 400 is moved (e.g., linearly) in the −X-axis direction provided for (e.g., defined) in the drawings by the inlet plug 100 fitted into the fastening socket 200, the conductor 710 located in the socket body 400 changes in position relative to the socket body 400.

In the charging connection device according to the example embodiment of the present disclosure, the state in which the socket body 400 is moved toward the operation surface 310 of the base 300 by the inlet plug 100 fitted into the fastening socket 200 is provided for (e.g., defined) as an “electrical connection state.” In the “electrical connection state,” the inlet plug 100 may be maintained in a state of being fitted in and coupled to the fastening socket 200.

In addition, in the “electrical connection state,” the direct contact area between the conductive terminal 110 and the conductive conductor 710 coupled (e.g., to each other) is maximized.

Conversely, when the inlet plug 100 is separated from the fastening socket 200, the shock-absorbing unit 320 is restored, and the socket body 400 returns to the original position thereof. As shown in FIG. 2, the conductor 710 in the socket body 400 is spaced apart from the inner side surface of the socket head 500 by an interval between “X4” and “X5.” In the example embodiment of the present disclosure, this state is provided (e.g., defined) as a “standby state.”

As described herein, the charging connection device according to the example embodiment of the present disclosure (e.g., systematically) operates in order to maximize the stability and efficiency of the charging system for the electric vehicle 1. The inlet plug 100 provided at the charging port 10 is coupled to the fastening socket 200 of the charging connector 20 to achieve an electrical connection.

The terminal 110 and the conductor 710 may be connected (e.g., to each other) while maintaining a (e.g., relatively) (e.g., large) contact area therebetween through the variable internal structure of the fastening socket 200. That is, because the fastening socket 200 provided at the charging connector 20 is designed in a variable structure, the contact area between the terminal 110 and the conductor 710 coupled (e.g., to each other) is maximized, whereby (e.g., stable) charging efficiency may be provided (e.g., ensured) during quick charging or ultra-fast charging.

In addition, the fastening socket 200 has a structure capable of absorbing vibration or external shock applied to the socket body 400, the socket head 500, and the moving plate 600.

The shock-absorbing unit 320 alleviates physical shock occurring during coupling and separation between the fastening socket 200 and the inlet plug 100, and provides for (e.g., allows) the contact area between the conductive terminal 110 and the conductive conductor 710 to be (e.g., variably) adjusted.

The socket body 400, the socket head 500, the moving plate 600, the spacer 610, the fixed plate 700, and the plug tip 120 may be provided in (e.g., made of) an insulative material.

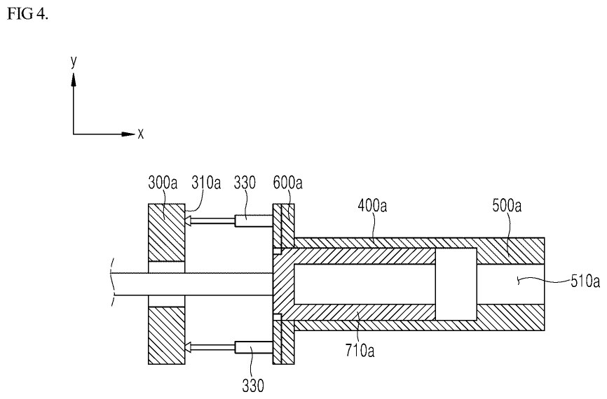

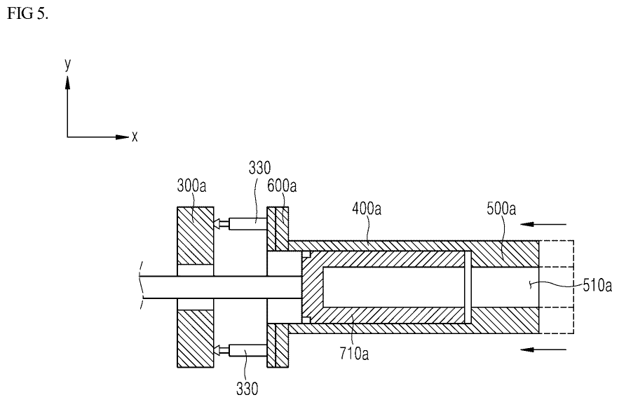

FIGS. 4 and 5 are cross-sectional views of a charging connection device for an electric vehicle 1a according to another example embodiment of the present disclosure.

As shown in FIGS. 4 and 5, the charging connection device for the electric vehicle 1a according to another example embodiment of the present disclosure may include a first damping unit 330 as a shock-absorbing unit 320a.

The first damping unit 330 may be implemented as a hydraulic or pneumatic cylinder. A plurality of first damping units 330 may be mounted between an operation surface 310a of a base 300a and a moving plate 600a formed along the periphery of an open surface of a socket body 400a.

As shown, the first damping unit 330 absorbs and alleviates external force applied to a socket body 400a in the −X-axis direction due to entry of an inlet plug 100a, and provides for (e.g., allows) the socket body 400a to move toward the operation surface 310a of the base 300a without impact.

In another example embodiment, a conductor 710a is fixed relative to the base 300a, and the socket body 400a accommodating the conductor 710a is slidable in the ±X-axis directions, e.g., the longitudinal direction of the conductor 710a.

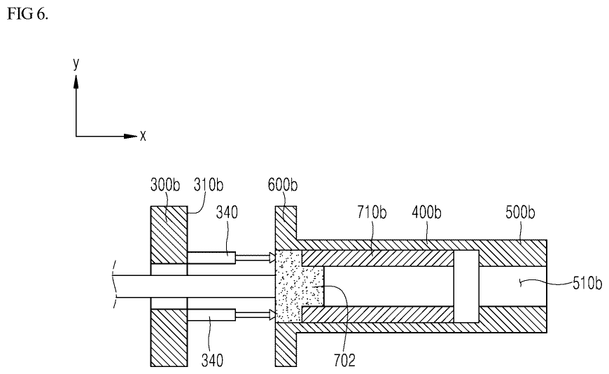

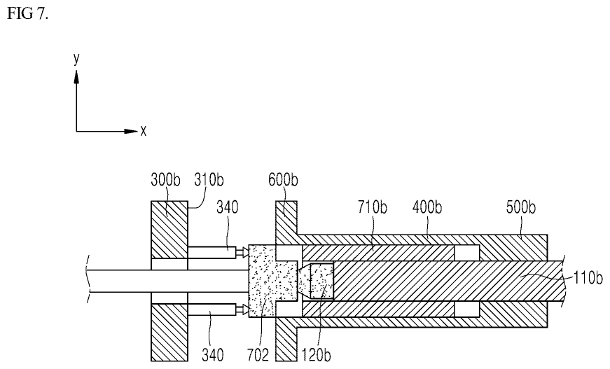

FIGS. 6 and 7 are cross-sectional views of a charging connection device for an electric vehicle 1b according to still another example embodiment of the present disclosure.

As shown in FIGS. 6 and 7, in the charging connection device according to the still other example embodiment of the present disclosure, a socket body 400b, a moving plate 600b, and a socket head 500b may be fixed relative to a base 300b. In addition, one end of a conductor 710b is coupled to a shock-absorbing end 702 made of an insulative material. The conductor 710b coupled to the shock-absorbing end 702 is reciprocally movable along a straight section in the ±X-axis directions in the socket body 400b along with movement of the shock-absorbing end 702.

In the still other example embodiment of the present disclosure, an operation surface 310b of the base 300b and the shock-absorbing end 702 may be connected (e.g., to each other) via a plurality of second damping units 340. Each of the second damping units 340 may be implemented as a shock absorber in which a damper and a spring are coupled (e.g., to each other).

In the charging connection device according to the still other example embodiment of the present disclosure, when an inlet plug 100b is fitted into the socket body 400b through a fastening hole 510b, a plug tip 120b and a terminal 110b apply external force to the conductor 710b in the −X-axis direction while entering a coupling recess formed in the conductor 710b. The conductor 710b may be coupled to the plug tip 120b and the terminal 110b that enter the coupling recess while (e.g., smoothly) moving toward the base 300b due to the second damping units 340 connected to the shock-absorbing end 702 that absorb external force and vibration.

As described herein, the charging connection device according to the present disclosure may be designed such that coupling between the charging port 10 and the charging connector 20 is optimized, and may create a connection environment providing (e.g., enabling) fast charging and ultra-fast charging.

According to the present disclosure, due to the structural characteristics of an inlet plug mounted to a charging port and a fastening socket provided at a charging connector, physical coupling between the charging terminal and the charging connector may be more securely achieved, whereby power may be stably transmitted, and charging efficiency may be improved.

According to the present disclosure, when the charging connector is coupled to the charging port, the charging connector is deformed so that the contact area between a conductive terminal and a conductive conductor increases, whereby heat generation caused by electrically connected portions may be prevented, and the possibility of damage thereto or deformation thereof may be reduced.

According to the present disclosure, external shock or vibration may be (e.g., effectively) dispersed and absorbed by a shock-absorbing unit provided between the charging port and the charging connector, a terminal may not be (e.g., easily) worn even by repeated coupling and separation between the charging port and the charging connector, and the durability of the charging connection parts may be improved.

The effects achievable through the disclosure are not limited to the effects mentioned herein, and other effects may be understood from the description herein.

The embodiments of the present disclosure have been described above with reference to the accompanying drawings. However, the embodiments are proposed for illustrative purposes, and the present disclosure is not limited to the above-described embodiments and the accompanying drawings.

Also, various changes in form and details may be made without departing from the scope and spirit of the disclosure.

The embodiments described herein are part of the present disclosure, and the embodiments described herein should not be construed as limiting the scope of the present disclosure.

The scope of the present disclosure should be taken into consideration in light of the appended claims.

In addition, actions or effects predictable from the configuration should also be recognized as falling within the present disclosure.

What is claimed is:

1. A charging connection device configured to be fastened to a charging port of an electric vehicle comprising an inlet plug comprising a conductive terminal and a plug tip coupled to a distal end of the terminal, the charging connection device comprising:
a charging connector connected to a charger to receive electrical energy, the charging connector being configured to be coupled to the charging port;
a fastening socket provided at the charging connector, the fastening socket being configured to allow the inlet plug to be fitted thereinto, wherein the terminal directly contacts a conductive conductor mounted therein; and
a shock-absorbing unit configured to be elastically deformed to allow the conductor to enter an electrical connection state when the inlet plug is fitted into the fastening socket and to allow the conductor to return to a standby state when the inlet plug is separated from the fastening socket.

2. The charging connection device according to claim 1, wherein the fastening socket comprises:
a base forming a portion of an outer side surface of the charging connector coupled to the charging port while facing the charging port;
a fixed plate configured to fix the conductor at a position in front of the base; and
a hollow cylindrical socket body comprising an open surface facing the base and a surface formed opposite the base and provided with a socket head,
wherein the shock-absorbing unit is a compression spring disposed between the base and the socket body, and
wherein, when external force is applied to the socket body, the shock-absorbing unit is elastically compressed to reduce an interval between the base and the socket body, and when the external force applied to the socket body is removed, the shock-absorbing unit allows the socket body to return to an original position thereof.

3. The charging connection device according to claim 2, wherein the socket body comprises:
a moving plate formed as an annular rim along an outer periphery of the open surface thereof facing the base; and
a spacer extending from the moving plate toward the base to limit a moving distance of the socket body approaching the base.

4. The charging connection device according to claim 3, wherein the socket body, the socket head, the moving plate, the spacer, and the fixed plate are made of an insulative material.

5. The charging connection device according to claim 2, wherein the electrical connection state is a state in which, as the socket body slides toward the base, the socket head approaches the conductor accommodated in the socket body, thereby increasing a direct contact area between the conductor and the terminal entering the socket body through the socket head.

6. The charging connection device according to claim 1, wherein the fastening socket comprises:
a base forming a portion of an outer side surface of the charging connector coupled to the charging port while facing the charging port;
a fixed plate configured to fix the conductor at a position in front of the base; and
a hollow cylindrical socket body comprising an open surface facing the base and a surface formed opposite the base and provided with a socket head,
wherein the shock-absorbing unit comprises a first damping unit provided between the base and the socket body, and
wherein the first damping unit alleviates vibration and shock applied to the socket body against the base.

7. The charging connection device according to claim 1, wherein the fastening socket comprises:
a base forming a portion of an outer side surface of the charging connector coupled to the charging port while facing the charging port;
a hollow cylindrical socket body fixed in front of the base, the socket body comprising an open surface facing the base and a surface formed opposite the base and provided with a socket head; and
a shock-absorbing end configured to allow one end of the conductor to be coupled thereto and to allow the conductor to enter the socket body through the open surface of the socket body and linearly reciprocate,
wherein the shock-absorbing unit comprises a second damping unit provided between the base and the shock-absorbing end, and
wherein, when external force is applied to the conductor, the second damping unit allows the shock-absorbing end to move toward the base, and when the external force applied to the conductor is removed, the second damping unit allows the shock-absorbing end to return to an original position thereof.

8. A charging connection device provided at an electric vehicle to allow a charging connector of a charger to be fastened thereto in order to charge a battery, the charging connection device comprising:
a charging port provided at the electric vehicle to allow the charging connector to be fastened thereto;
a conductive terminal protruding linearly forward from the charging port;
a pressing end protruding outward along an outer periphery of a lower end portion of the terminal to have a stepped shape; and
a plug tip provided at a front end of the terminal.

9. The charging connection device according to claim 8, wherein the plug tip is made of an elastically deformable insulative material.
